(19) United States
(12) Patent Application Publication
(10) Pub. No.: US 2025/0337581 A1
(43) Pub. Date: Oct. 30, 2025

(54) Mechanisms for Utilizing Tokens and Cryptograms in Operations

(71) Applicant: PayPal, Inc., San Jose, CA (US)

(72) Inventors: Karl Hirschhorn, Folsom, CA (US); Abhishek Kakani, Danville, CA (US); Venkat Raman Don, Bellevue, WA (US); Trini George, Milpitas, CA (US); Andrew Throener, Omaha, NE (US)

(21) Appl. No.: 19/186,328

(22) Filed: Apr. 22, 2025

Related U.S. Application Data
(60) Provisional application No. 63/638,231, filed on Apr. 24, 2024.

(51) Int. Cl. H04L 9/32

(52) U.S. Cl. CPC H04L 9/3213

(57) ABSTRACT

Techniques are disclosed relating to utilizing tokens and cryptograms in operations. A first service provider system receives a request to provide a network token usable by a second service provider system to request performance of an operation at an operations system. The first service provider system sends a request to the operations system to generate and return the network token. The network token is usable with a cryptogram to collectively cause the operations system to perform the operation. The first service provider system provides the network token to a web service system. After providing the network token, the first service provider system receives a request indicative that the web service system seeks to initiate the operation. The first service provider system provides the cryptogram to the web service system to enable it to initiate the operation via the second service provider system using the network token and the cryptogram.

### PRIORITY CLAIM

The present application claims priority to U.S. Provisional Appl. No. 63/638,231, filed Apr. 24, 2024, which is incorporated by reference herein in its entirety.

### BACKGROUND

### Technical Field

This disclosure relates generally to computer systems and, more specifically, to various mechanisms for utilizing tokens and cryptograms in operations.

### Description of the Related Art

Services provided through software applications often form a hierarchical structure in which a higher-level service utilizes the functionality provided by a lower-level service of that hierarchical structure. In many cases, the higher-level service enables a yet higher-level service to utilize or otherwise benefit from the functionality of the lower level service while hiding the complexity involved in interacting with the lower level service. As an example, the lower level service may provide a complex application programming interface (API) while also potentially requiring compliance with certain requirements or regulations (e.g., a certain level of computer security for data, including protected storage of that data and secure transfer of that data to and from the lower-level service). By hiding this complexity, the higher level service can simplify at least a portion of the development of the yet higher-level service as the developer does not have to focus on managing interactions with the lower-level service.

One example of a service provider hierarchy involves Infrastructure as a Service (IaaS) providers, Platform as a Service (PaaS) providers, and Software as a Service (SaaS) providers. At the base of this service provider hierarchy are the IaaS providers, an IaaS provider typically provides computer resources (e.g., computing, storage, networking, etc.) in a virtualized form via the Internet. At the next higher level are the PaaS providers, a PaaS provider implements a platform that allows users to deploy, run, and manage custom cloud applications without the complexity of building and maintaining servers and infrastructure. The PaaS provider interacts with the IaaS provider to manage the provisioning of the computer resources provided by the IaaS provider. At the next higher level are the SaaS providers, a SaaS provider provides cloud-based applications to users. The SaaS provider interacts with the PaaS provider to deploy their applications using the platform provided by the PaaS provider.

### BRIEF DESCRIPTION OF THE DRAWINGS

FIG. 1A is a block diagram illustrating a system that includes multiple service provider systems, a web service system, and an operations system, according to some embodiments.

FIG. 1B is a block diagram illustrating an example relating to a service provider system providing tokens and cryptograms to multiple web service systems that are usable by different service provider systems, according to some embodiments.

FIG. 2A-B are block diagrams illustrating different approaches relating to a web service system acquiring tokens from a service provider system, according to some embodiments.

FIG. 3 is a block diagram illustrating an approach relating to a service provider system obtaining tokens and cryptograms, according to some embodiments.

FIG. 4 is a block diagram illustrating an example in which a web service system acquires a token and multiple cryptograms from a service provider system for use in multiple operations associated with another service provider system, according to some embodiments.

FIG. 5 is a block diagram illustrating an example that pertains to the use of tokens and cryptograms in a transaction processing architecture, according to some embodiments.

FIG. 6 is a block diagram illustrating an approach relating to a service provider system revoking tokens, according to some embodiments.

FIGS. 7-9 are flow diagrams illustrating example methods that pertain to using tokens and cryptograms to facilitate operations, according to some embodiments.

FIG. 10 is a block diagram illustrating elements of a computer system for implementing various systems described in the present disclosure, according to some embodiments.

### DETAILED DESCRIPTION

Service provider systems that provide services via applications often form a hierarchy. For a given level of the hierarchy, there can be multiple service provider systems that provide services that overlap in at least a portion of their functionality. As an example, multiple PaaS provider systems may interact with the same IaaS provider system and allow for SaaS provider systems to deploy, run, and manage their applications without worrying about interacting with the IaaS provider to provision computer resources. But in many cases, a first service provider system provides certain functionality that is not provided by a second service provider system. A higher-level service provider may wish to use this functionality, but their system may already be designed to interact with the second service provider system and therefore the higher-level service provider may not wish to switch to the first service provider system as their primary service provider for that level of the hierarchy. This disclosure addresses, among other things, this technical problem of how to provide functionality to a higher-level service provider system without the service provider having to switch from another service provider system.

As one non-limiting example that pertains to this problem, a merchant may provide an online retail store via a web service system that allows users to conduct transactions to acquire goods and services from that merchant. The merchant may use a transaction processor system (e.g., ADYEN) to facilitate those transactions—the transaction processor system interacts with a payment network (e.g., VISA) to conduct the transactions. By using a transaction processor system, that merchant does not have to spend a considerable amount of time integrating with the various payment networks and complying with financial regulations associated with that integration. But in many cases, the transaction processor system does not provide functionality that is provided by another transaction processor system (e.g., PAYPAL). As an example, that other transaction processor system (referred to as a “first transaction processor system” in this example) may provide an express checkout service that allows users to conduct a transaction with a merchant without having to manually enter their financial instrument information (e.g., credit card details). This functionality can be beneficial to the merchant since users often forgo a purchase upon reaching the checkout window. But the merchant may not wish to switch their system over from using their current transaction processor system (referred to as a “second transaction processor system” in this example).

One approach to resolving this problem is for the first transaction processor system to provide the user's financial instrument information to the merchant so that the merchant can provide it to the second transaction processor system. But this approach runs afoul of privacy concerns of the users that use the express checkout service. Another approach is for the first transaction processor system to be designed to use the APIs of the second transaction processor system so that the first transaction processor system can facilitate transactions via the second transaction processor system on behalf of the merchant. But there are many transaction processor systems and, as a result, integrating with all of them takes an enormous amount of time and resources, especially as the landscape is constantly changing. Thus, these approaches are deficient. This disclosure addresses this technical problem of how to provide functionality to a merchant's system without the merchant having to switch from their transaction processor system.

In various embodiments described below, a system comprises a first service provider system, a second service provider system, a web service system, and an operations system. The web service system may provide a web service that allows users to perform operations, where the operations are implemented in part by the operations system. When a user seeks to perform an operation in association with the web service system, in various embodiments, the first service provider system receives a request to provide, to the web service system, a network token usable by the second service provider system to request performance of the operation at the operations system on behalf of the user. In response to receiving the request, the first service provider system sends a request to the operations system to generate and return the token. In various embodiments, the network token is service provider system independent and usable with a cryptogram to collectively cause the operations system to perform the operation. The first service provider system provides the network token without a cryptogram to the web service system. The web service system may delay initiating the operation for a period of time. When the web service system seeks to initiate the operation, the first service provider system receives a request to provide a cryptogram. The first service provider system may obtain the cryptogram from the operations system. The first service system provides the cryptogram to the web service system to enable that web service system to initiate the operation via the second service provider system using the network token and the cryptogram.

Continuing the non-limiting example, when a transaction is to be conducted between a merchant and a user, in various embodiments, the first transaction processor system receives a request to provide, to a merchant system associated with the merchant, a network token usable by the second transaction processor system to facilitate the transaction. Based on transaction information associated with the transaction, the first transaction processor system may identify a payment network system that is capable of facilitating the transaction. The first transaction processor system sends a request to the payment network system to return the network token, which can be used with a cryptogram to collectively cause a card issuer system associated with the payment network system to perform the transaction. The first transaction processor system thereafter provides the network token without a cryptogram to the merchant system, in various embodiments. After providing that network token to the merchant system, the first transaction processor system may receive a request from the merchant system that indicates that it seeks to complete the transaction. The first transaction processor system provides a cryptogram to the merchant system that enables the merchant system to conduct the transaction via the second transaction processor system using the network token and the cryptogram.

While the non-limiting example relates to service provider systems that are transaction processors providing web services through which users (e.g., merchants) can perform financial transactions, service provider systems can provide services that are not financial in nature. For example, a service provider system may provide a streaming media service, an email service, host a website, etc. Further, the term “transaction” does not necessarily refer to an interaction between a transaction processor system and a user that is financial in nature. In embodiments in which transaction processor systems provide a financial web service, the “transactions” can be financial transactions. But in other embodiments in which the transaction processor systems provide a service that is not financial in nature (e.g., a PaaS that provides a database system), the “transaction” can refer to non-financial interactions (e.g., database transactions) between the transaction processor system and a user.

These techniques may be advantageous over prior approaches as these techniques allow for a service provider system to provide functionality to a higher-level service provider system without the service provider of the higher-level service provider system having to switch from another service provider system. In the case of the non-limiting example relating to the express checkout service, the first transaction processor system is able to provide this service to the merchant system without having to provide a user's financial information to the merchant or having to integrate with other transaction processor systems, addressing the deficiencies of the other mentioned approaches. Thus, by employing transaction-processor-system-independent network tokens and cryptograms, a transaction processor system can allow a merchant system to retain its integration with another transaction processor system while being able to benefit from the additional functionality that is provided by the former transaction processor system. As a result, this field of transaction processing is improved by this paradigm. As discussed, this approach can be extended beyond transaction processing to other types of service provider systems such that a higher-level service provider system (e.g., a SaaS provider system) can use functionality from different service provider systems (e.g., PaaS provider systems) that are in the next lower level of a service provider hierarchy.

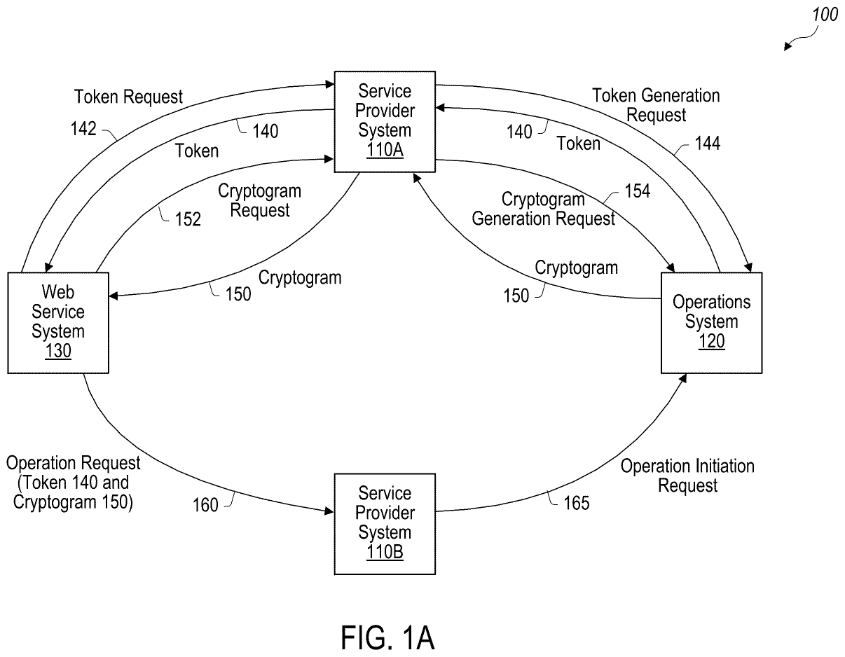

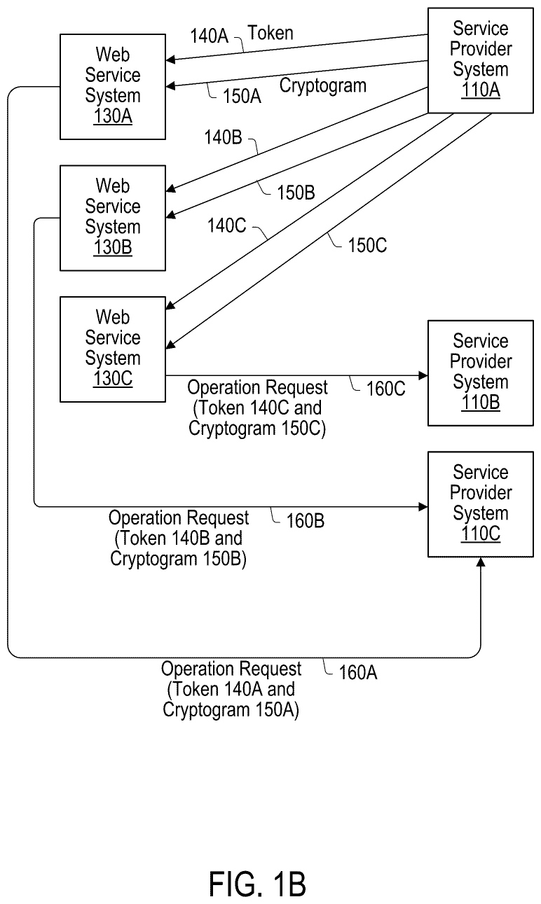

Turning now to FIG. 1A, a block diagram of a system 100 is shown. System 100 includes a set of components that may be implemented via hardware or a combination of hardware and software routines. In the illustrated embodiment, system 100 includes service provider systems 110A and 110B, an operations system 120, and a web service system 130. System 100 may be implemented differently than shown. For example, there may be additional service provider systems 110 that reside between web service system 130 and service provider systems 110A and 110B. Further, the number of components of system 100 may vary between embodiments. Thus, there can be more or fewer of each component than the number shown in FIG. 1A—e.g., service provider system 110A may provide tokens 140 and cryptograms 150 to multiple web service systems 130, an example of which is discussed with respect to FIG. 1B.

In various embodiments, one or more components of system 100 are implemented via a cloud infrastructure provided by a cloud provider. For example, web service system 130 may use the available cloud resources of a cloud infrastructure (e.g., computing resources, storage resources, etc.) in order to facilitate its operation. Accordingly, software for implementing the service(s) of web service system 130 (or another component of system 100) may be stored on a non-transitory computer-readable medium of server-based hardware included in a datacenter of the cloud provider and executed in a virtual machine hosted on that server-based hardware. In some cases, a component is implemented without the assistance of a virtual machine or other deployment technologies, such as containerization. In some cases, one or more components of system 100 are implemented via local or private infrastructure as opposed to a public cloud.

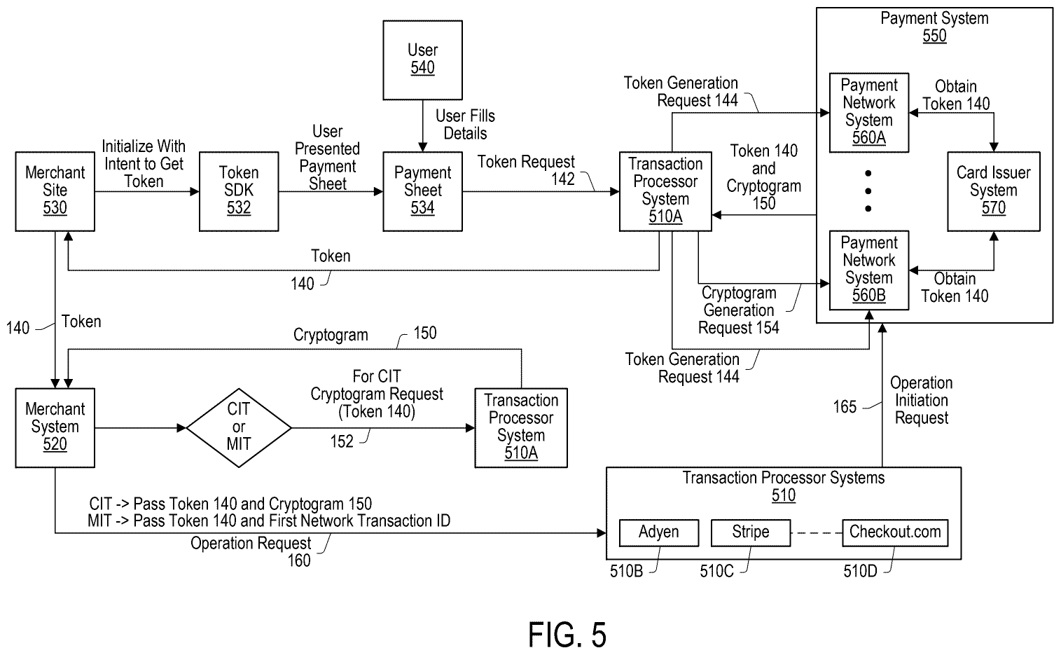

Service provider systems 110, in various embodiments, are systems that provide one or more services that are accessible to entities (e.g., users and other service provider systems 110) via communication networks. Examples of services that can be provided by a service provider system 110 include an email service, a streaming service, a resource provisioning service (e.g., an IaaS), a platform service (e.g., a PaaS), a web service (e.g., a retail website), and an online payment/transaction processing service. In various embodiments, service provider systems 110A and 110B provide at least the same type of service(s) and thus overlap in at least a portion of the functionality that they provide, although service provider systems 110A and 110B may also provide other, different services. For example, an embodiment is discussed with respect to FIG. 5 in which service provider systems 110 are transaction processor systems that provide a web service that allows for users/merchants to perform transactions (e.g., a service associated with a bank or online payment system). But this embodiment is provided merely as an example and is not intended to limit the scope of this disclosure. Furthermore, in some embodiments, service provider systems 110A and 110B provide different types of services and do not provide the same type of service.

While service provider systems 110 can provide the same types of service(s), in various embodiments, the functionality that they provide through the services can differ. For example, service provider systems 110A and 110B may both provide a PaaS that implements a database system that stores data for user applications. Service provider system 110A may provide both relational and non-relational databases to user applications while service provider system 110B provides only relational databases. As an example within the context of transaction processing, service provider systems 110A and 110B may both be transaction processor systems, but only service provider system 110A provides express checkout functionality that allows for users to conduct transactions without having to manually enter their financial instrument information. Further, in some cases, service provider systems 110A and 110B provide the same feature(s), but they implement them differently, where one implementation may more efficiently utilize resources than the other implementation. Consequently, a provider of web service system 130 may wish to integrate or otherwise be able to utilize functionality provided by different service provider systems 110.

As discussed, systems that provide services can form a hierarchy in which one system uses the functionality of another system in the hierarchy. Service provider systems 110A and 110B, operations system 120, and web service system 130 form a hierarchy. At the top of this hierarchy is web service system 130, which utilizes functionality provided by service provider systems 110A and 110B that constitute the next, lower level in this hierarchy. Service provider systems 110A and 110B, in turn, integrate with operations system 120 to utilize functionality provided by operations system 120, which resides at the bottom of this example hierarchy. In many cases, a system at a particular level in a hierarchy enables a higher-level system to utilize or otherwise benefit from functionality provided by a system in a lower level than the particular level. For example, in the context of transaction processing, operations system 120 may include a payment network that interacts with banking systems to facilitate transactions. Web service system 130 may provide an online retail store, and thus a provider of web service system 130 may wish to conduct transactions with users. Accordingly, service provider systems 110A and 110B can integrate with that payment network and any other payment networks to enable web service system 130 to conduct transactions through those payment networks while hiding the complexity involved in interacting with the payment networks.

Operations system 120, in various embodiments, is a system that provides one or more services having functionality that can be invoked using tokens 140. In the context of transaction processing, a payment system (comprising a payment network and a card issuer system) is an example of operations system 120. Since operations system 120 provides one or more services, operations system 120 can be considered a type of service provider system. A token 140 (also referred to as a network token), in various embodiments, comprises data that is understood by operations system 120 and can be provided to operations system 120 to cause it to perform one or more operations. Token 140 may include a string value of alphanumeric characters that is generated by operations system 120. For example, in the context of transaction processing, token 140 may include a 16-digit primary account number along with other information, such as a card expiration date, a security code, merchant details, etc. Token 140 may be provided to operations system 120 to cause it to perform a transaction between different entities (e.g., a merchant and a customer). In other contexts, token 140 may include entity credentials along with an indication of the operation(s) for which the entity has been approved. As an example, token 140 may indicate computer resources that an IaaS provider system will provision for a SaaS provider system and therefore may be provided to the IaaS provider system to cause it to provision those resource. In various embodiments, token 140 is also cryptographically signed by operations systems 120—at least a portion or all of the contents included in token 140 may be encrypted.

In addition to generating and providing tokens 140, in various embodiments, operations system 120 can also generate and provide cryptograms 150 that are usable with tokens 140 to collectively cause operations system 120 to perform operations. Thus, operations system 120 may reject a request to perform a certain operation if that request provides only token 140 without a cryptogram 150. Cryptogram 150, in various embodiments, includes data associated with token 140 by operations system 120 such that operations system 120 can determine that cryptogram 150 was generated for token 140. For example, cryptogram 150 may include a message that is cryptographically signed or hashed by operations system 120. In some cases, token 140 may be used without cryptogram 150 in subsequent requests to an initial request that used token 140 and cryptogram 150.

Web service system 130, in various embodiments, is a system that provides a website-based service accessible to users via user devices. Since web service system 130 can provide one or more services, it can be considered a type of service provider system. Thus, while web service system 130 can provide a website, in some embodiments, web service system 130 is a service provider system 110 that provides other types of services. In various embodiments, the service(s) provide by web service system 130 involve execution/transaction flows comprising various steps, at least one of which can involve having operations system 120 perform certain operations. Further, other steps in the flows can involve having service provider systems 110A and/or 110B perform certain operations.

For example, web service system 130 may facilitate an execution flow that involves allocating computer resources to an environment, and service provider system 110B may be a PaaS provider and operations system 120 may be an IaaS provider. The execution flow may include a step in which web service system 130 issues a request to service provider system 110B to allocate the resources, a step in which service provider system 110B communicates with operations system 120 to allocate the resources, and a step in which operations system 120 allocates the resources. As another example, in the context of transaction processing, web service system 130 may facilitate an execution flow that involves conducting a transaction between a merchant and a customer. The execution flow may include a step in which service provider system 110A implements a express checkout function for the customer, a step in which web service system 130 issues a request to service provider system 110B to perform the transaction, a step in which service provider system 110B communicates with operations system 120 to perform the transaction, and a step in which operations system 120 performs the transaction.

In order to allow for multiple service provider systems 110 to contribute to an execution flow, in various embodiments, tokens 140 and cryptograms 150 are used. As part of its portion of an execution flow, service provider system 110A may obtain and provide token 140 to web service system 130. As shown, web service system 130 issues a token request 142 to service provider system 110A for token 140. Based on receiving that request, service provider system 110A obtains token 140 from operations system 120 (via a token generation request 144) and then returns token 140 to web service system 130. Thereafter, when web service system 130 seeks to involve service provider system 110B in the execution flow, web service system 130 may issue a cryptogram request 152 to service provider system 110A for cryptogram 150. Accordingly, service provider system 110A obtains cryptogram 150 from operations system 120 (via a cryptogram generation request 154) and returns it to web service system 130. Web service system 130 then issues an operation request 160 (with token 140 and cryptogram 150) to service provider system 110B to perform its portion of the execution flow. Service provider system 110B then issues an operation initiation request 165 (with token 140 and cryptogram 150) to operations system 120 to perform operations. Operations system 120 may validate token 140 and cryptogram 150 and, in response to determining that they are valid, perform the requested operations.

As a non-limiting example, service provider system 110A may be a payment processor system (e.g., implemented by PAYPAL), service provider system 110B may also be a payment processor system (e.g., implemented by ADYEN), operation system 120 may be a payment network (e.g., implemented by VISA), and web service system 130 may implement a merchant website. Service provider system 110A may provide an express checkout service that allows users to conduct transactions with a merchant without having to manually enter their financial information (e.g., their credit card details). The merchant may wish to use this express checkout service (so that users do not have to manually input all of their information during a transaction) and thus may incorporate functionality into their website to interact with the service. Using the techniques discussed herein, the merchant may use this service provided by service provider system 110A without decoupling from service provider system 110B.

When a user visits the merchant's website and starts a transaction with the merchant to obtain a good or service, web service system 130 (the merchant's system) may issue a token request 142 to service provider system 110A, and service provider system 110A may interact with operations system 120 (the payment network in this non-limiting example) to obtain token 140. Service provider system 110A may then return token 140 to web service system 130. At a later point in time (e.g., the end of the day), web service system 130 may issue a cryptogram request 152 to service provider system 110A, and service provider system 110A may interact with operations system 120 to obtain cryptogram 150. Service provider system 110A may then return cryptogram 150 to web service system 130. Web service system 130 may then provide token 140 and cryptogram 150 to service provider system 110B as part of a request to complete the transaction. Service provider system 110B may then interact with operations system 120 to complete the transaction using token 140 and cryptogram 150. Accordingly, in this example, the merchant is able to use the express checkout service provided by service provider system 110A while still using the payment processing capabilities of service provider system 110B by leveraging token 140 and cryptogram 150.

Turning now to FIG. 1B, a block diagram of an example in which a service provider system 110 provides tokens 140 and cryptograms 150 to multiple web service systems 130 that are usable by different service provider systems 110 is shown. In the illustrated embodiment, there are service provider systems 110A-C and web service systems 130A-C. The illustrated embodiment may be implemented differently than shown. For example, a web service system 130 may issue operation requests 160 to multiple service provider systems 110.

While FIG. 1A depicts a single web service system 130, a service provider system 110 may integrate with or otherwise support multiple web service systems 130, as shown in FIG. 1B. Those web service systems 130 can integrate with different service provider systems 110 and multiple of them can integrate with the same service provider system 110. As shown for example, web service system 130A and 130B integrate with service provider system 110C while web service system 130C integrates with service provider system 110B. In various embodiments, tokens 140 (and cryptograms 150) are service provider independent such that a given token 140 can be provided to different service provider systems 110 that use it to cause an operations system 120 to perform certain operations.

Further, in various embodiments, a service provider system 110 may utilize tokens 140 and cryptograms 150 from various web service systems 130 to cause an operations system 120 to perform certain operations for the web service systems 130, respectively. As shown, service provider system 110A provides a token 140A and a cryptogram 150A to web service system 130A, a token 140B and a cryptogram 150B to web service system 130B, and a token 140C and a cryptogram 150C to web service system 130C. As further shown, web service systems 130A and 130B provide their tokens 140 and cryptograms 150 to service provider system 110B in operations requests 160A and 160B, respectively. Service provider system 110B may then provide those tokens 140 and cryptograms 150 to an operations system 120 to perform certain operations for both web service systems 130A and 130B. In various embodiments, there may be multiple operations systems 120. Accordingly, service provider system 110B may provide token 140C and cryptogram 150C (which are received via an operation request 160C from web service system 130C) to an operations system 120 that is different than the operations system 120 performing operations for web service systems 130A and 130B.

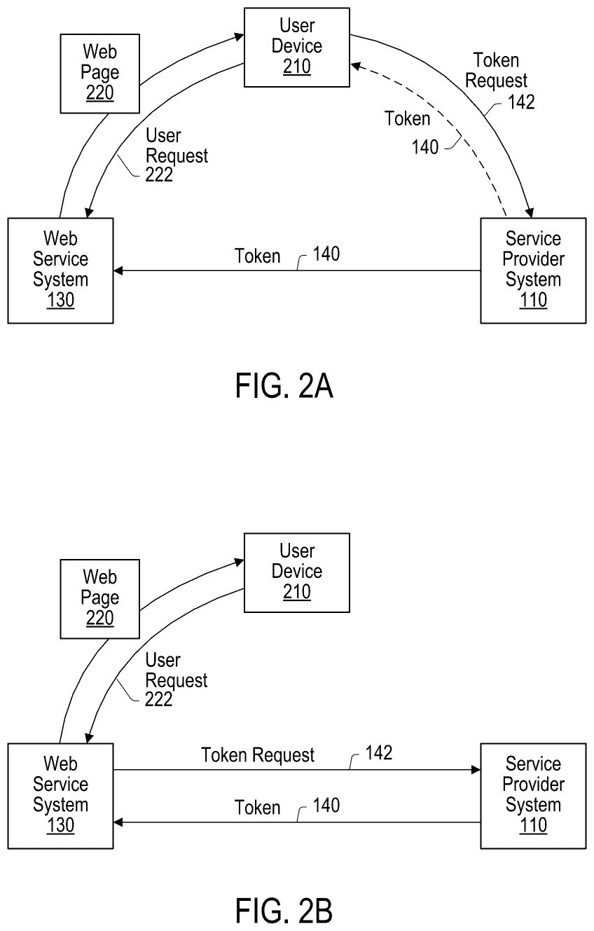

Turning now to FIG. 2A, a block diagram of an example approach that pertains to a web service system 130 acquiring tokens 140 from a service provider system 110 is shown. In the illustrated embodiment, there is a service provider system 110, a web server system 130, and a user device 210. As further shown, web service system 130 receives a token 140 from service provider system 110. While user device 210 is shown as participating in the acquisition of token 140 in the illustrated embodiment, in some embodiments, web service system 130 acquires token 140 outside of any interaction with user device 210. As an example, web service system 130 may wish to implement an execution flow that does not involve users and thus web service system 130 may acquire token 140 for that execution flow without communicating with user device 210.

User device 210, in various embodiments, can be any of a variety of different computer systems that a user can use to interact with web service system 130. Examples of user devices 210 include desktop computers, laptops, mobile phones, smartwatches, TV s, etc. As discussed, in various embodiments, web service system 130 provides a website-based service accessible to users via user devices 210. The website of that service may comprise various web pages 220 that can be written in HTML (hypertext markup language) and viewed by a user via a web browser on user device 210. In some embodiments, a provider of web service system 130 provides an application that can be executed on user device 210—e.g., the user might download a native application onto their smartphone via an application store.

As discussed, service provider systems 110 can provide functionality (e.g., an express checkout capability) to web service systems 130. In order to make that functionality available, in various embodiments, a service provider develops and provides a software development kit (SDK) that can act as a bridge between the web service system's service and the service provider system's service. For example, the SDK may include functions that can be called to issue token requests 142 and cryptogram requests 152 to service provider system 110. Thus, the SDK may allow for the provider of web service system 130 to acquire tokens 140 and cryptograms 150 without having to understand the intricate details of the service provider system's API. The aspects of the SDK may be incorporated into the website of web service system 130 by linking/importing it into code of web pages 220 of that website (or into an application made available to a user to downloaded to user device 210). When a web page 220 that uses the SDK is sent to user device 210 and executed, or when user device 210 executes an application the uses the SDK, in various embodiments, the SDK is initialized to request tokens 140. A user may issue, to web service system 130, a user request 222 indicating that the user wishes to perform an operation with respect to web service system 130—e.g., conduct a transaction between the user and a merchant associated with web service system 130. As part of issuing user request 222, the web page code executing at user device 210 may invoke one or more functions of the SDK to issue a token request 142 to service provider system 110.

In response to receiving token request 142, service provider system 110 may obtain and return token 140 to web service system 130 for performing the operation. Token request 142, in various embodiments, includes information pertaining to the user, user device 210, the provider of web service system 130, and/or web service system 130 itself. For example, in the context of transaction processing, token request 142 may include merchant information about a merchant of web service system 130 and transaction instrument information that describes a transaction instrument of the user. Service provider system 110 may obtain token 140 based on the information included in token request 142. Token request 142 may also include other information, such as a return method. In some cases, service provider system 110 provides token 140 to web service system 130 by routing it through user device 210 (e.g., by returning it to user device 210, which provides it to web service system 130 by incorporating it in user request 222 for example). In other cases, service provider system 110 provides token 140 to web service system 130 without routing it through user device 210.

Furthermore, in some embodiments, service provider system 110 may provide a nonce or other information to web service system 130 instead of token 140. The nonce or other information may be used by web service system 130 in a subsequent request to obtain token 140 and/or a cryptogram 150 from service provider system 110. For example, in the context of transaction processing, when web service system 130 seeks to actually perform the transaction after a period of time, web service system 130 may return the nonce to service provider system 110 to receive token 140 and/or a cryptogram 150. In some embodiments, service provider system 110 does not obtain token 140 and/or a cryptogram 150 until web service system 130 provides the nonce or other information.

Turning now to FIG. 2B, a block diagram of another example approach that pertains to a web service system 130 acquiring tokens 140 from a service provider system 110 is shown. In the illustrated embodiment, there is a service provider system 110, a web server system 130, and a user device 210. As further shown, web service system 130 receives a token 140 from service provider system 110. In FIG. 2A, user device 210 issues a token request 142 to service provider system 110 on behalf of web service system 130. But in various embodiments, such as the one shown in FIG. 2B, web service system 130 issues token request 142 to service provider system 110. In particular, using user device 210, a user may issue, to web service system 130, a user request 222 indicating that the user wishes to perform an operation with respect to web service system 130. In response to user request 222, in various embodiments, web service system 130 issues token request 142 to service provider system 110 to provide token 140 to web service system 130 for the operation. As such, service provider system 110 may obtain and return token 140 to web service system 130 for performing the operation.

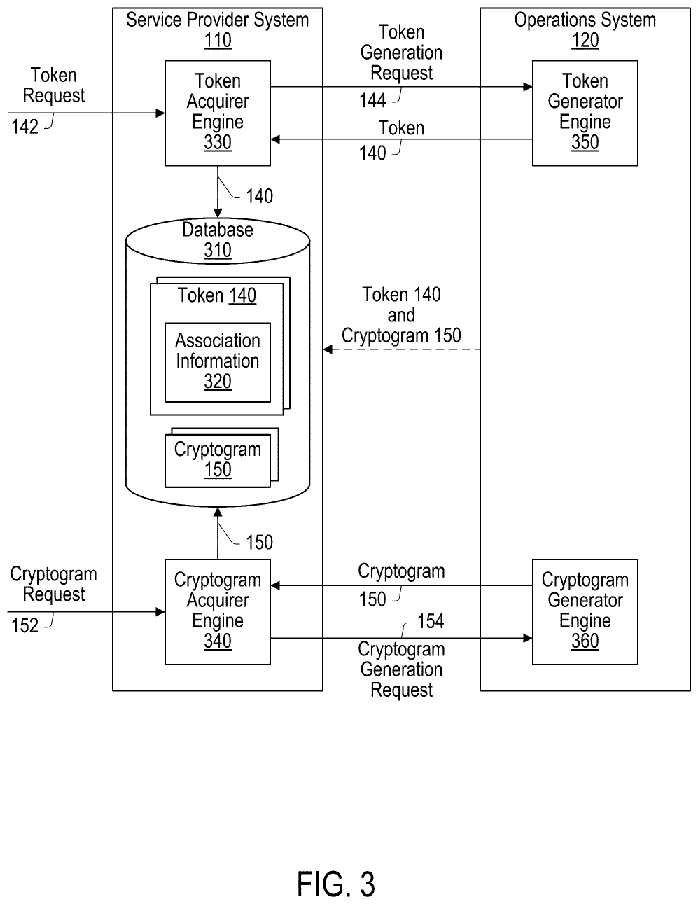

Turning now to FIG. 3, a block diagram of an example approach pertaining to a service provider system 110 obtaining tokens 140 and cryptograms 150 is shown. In the illustrated embodiment, there is a service provider system 110 and an operations system 120. As shown, service provider system 110 includes a database 310 (storing tokens 140 and cryptograms 150), a token acquirer engine 330, and a cryptogram acquirer engine 340. A Iso as shown, operations system 120 includes a token generator engine 350 and a cryptogram generator engine 360. A s shown, token acquirer engine 330 receives a token 140 from token generator engine 350, and cryptogram acquirer engine 340 receives a cryptogram 150 from cryptogram generator engine 360. The illustrated embodiment may be implemented differently than shown. For example, instead of obtaining tokens 140 and/or cryptograms 150 from operations system 120, service provider system 110 may locally generate tokens 140 and/or cryptograms 150.

Database 310, in various embodiments, is a collection of information that is organized in a manner that allows for access, storage, and/or manipulation of that information. Database 310 may include supporting software (e.g., storage servers) that enables a database server to carry out those operations (e.g., accessing, storing, etc.) on the information stored at database 310. In various embodiments, database 310 is implemented using a single or multiple storage devices that are connected together on a network (e.g., a storage attached network (SAN)) and configured to redundantly store information to prevent data loss. As discussed, components of system 100 may utilize the available cloud resources of a cloud infrastructure and thus the data of database 310 may be stored using a storage service that is provided by a cloud provider (e.g., AMAZON S3).

As shown, database 310 includes tokens 140 and cryptograms 150 that are obtained by token acquirer engine 330 and cryptogram acquirer engine 340, respectively. In various cases, service provider system 110 stores tokens 140 and cryptograms 150 for multiple, different web service systems 130, including multiple tokens 140 for the same web service system 130. For example, a web service system 130 may seek to perform operations at operations system 120 on behalf of different users. Consequently, service provider system 110 may store a respective token 140 for each user in association with that web service system 130. Tokens 140, in various embodiments, include or are associated with association information 320 that associates a given token 140 with various pieces of information, such as the web service system 130 associated with that given token 140, the type of operation that will be performed by operations system 120, any users involved in that operation, input parameters to the operation, etc. Service provider system 110 may store multiple cryptograms 150 for the same token 140. While not shown, cryptograms 150 can also include or be associated with association information that associates a given cryptogram 150 with various pieces of information, such as its associated token 140, an expiration time/duration indicating when that given cryptogram 150 becomes invalid and no longer usable, which operations system 120 generated that given cryptogram 150, etc.

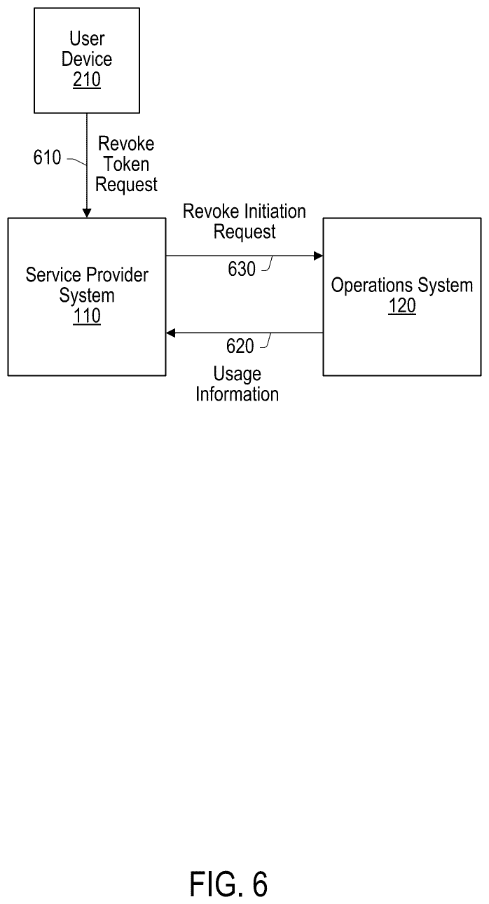

Service provider system 110 may delete tokens 140 and cryptograms 150 from database 310 for a variety of reasons. When tokens 140 or cryptograms 150 expire, service provider system 110 may delete those tokens 140 or cryptograms 150. As discussed in greater detail with respect to FIG. 6, a user may request that a particular token 140 be revoked and thus service provider system 110 may delete that particular token 140. In some cases, operations system 120 may indicate that certain tokens 140 or cryptograms 150 has become invalid and thus service provider system 110 may delete those tokens 140 or cryptograms 150. After a particular cryptogram 150 has been used by a web service system 130 or after it has been provided to the web service system 130, service provider system 110 may delete that particular cryptogram 150.

Token acquirer engine 330, in various embodiments, is software that is executable to obtain token 140. In order to obtain token 140, token acquirer engine 330 may request token 140 from operations system 120 or generate it. Upon receiving a token request 142, in various embodiments, token acquirer engine 330 issues a token generation request 144 to token generator engine 350 (or, more broadly, operations system 120) that requests token 140. Token generation request 144 may include various information that enables operations system 120 to generate token 140. For example, token generation request 144 may include a unique Token Requestor ID (TRID) associated with service provider system 110, details about web service system 130 and/or its provider, and input parameters for the operation(s) that will be performed by operations system 120. The TRID may be obtained by a provider of service provider system 110 upon registering with operations system 120 and can be used to indicate that service provider system 110 has authority/approval to issue token generation requests 144 to operation systems 120 via an API that is provided by operations system 120. In the context of transaction processing, token generation request 144 may include a TRID associated with a transaction processor system (a type of service provider system), merchant information that describes a merchant of a web service system 130, and transaction instrument information that describes a transaction instrument associated with a user/customer involved in a transaction with the merchant. At least a portion of the information included in token generation request 144 may be obtained from token request 142—e.g., token request 142 may include merchant details and/or transaction instrument information. As discussed below, token generator engine 350, in various embodiments, generates token 140 based on the information that is included in token generation request 144.

Upon receiving token request 142, in some embodiments, token acquirer engine 330 generates token 140. In some embodiments, to generate token 140, token acquirer engine 330 encrypts information (e.g., the information included in token request 142 along with a TRID) using a public key associated with operations system 120 and cryptographically signs the information with a private key associated with service provider system 110, producing token 140. In some embodiments, to generate token 140, token acquirer engine 330 communicates with operations system 120 to obtain information (e.g., a nonce) that token acquirer engine 330 cryptographically signs to generate token 140. Thus, generating token 140 may be a joint effort between service provider system 110 and operations system 120. After obtaining token 140, in various embodiments, token acquirer engine 330 stores it in database 310 and returns it to the issuer of the corresponding token request 142. In some embodiments, token acquirer engine 330 returns a nonce or other information (instead of the token 140) that can used to later request token 140 from service provider system 110.

Cryptogram acquirer engine 340, in various embodiments, is software that is executable to obtain cryptogram 150. In order to obtain cryptogram 150, cryptogram acquirer engine 340 may request cryptogram 150 from operations system 120 or generate it. Upon receiving a cryptogram request 152, in various embodiments, cryptogram acquirer engine 340 issues a cryptogram generation request 154 to cryptogram generator engine 360 (or, more broadly, operations system 120) that requests cryptogram 150. Cryptogram generation request 154 may include information that enables operations system 120 to generate cryptogram 150. For example, the cryptogram generation request 154 may include a TRID associated with service provider system 110 and token 140. At least a portion of the information that is included in cryptogram generation request 154 may be obtained from cryptogram request 152. As discussed below, cryptogram generator engine 360 may generate cryptogram 150 based on the information included in cryptogram generation request 154.

Upon receiving cryptogram request 152, in some embodiments, cryptogram acquirer engine 340 generates cryptogram 150. In some embodiments, to generate cryptogram 150, cryptogram acquirer engine 340 obtains information (e.g., a nonce) from operations system 120 and cryptographically signs it to produce cryptogram 150. Thus, generating cryptogram 150 may be a joint effort between service provider system 110 and operations system 120. In some embodiments, cryptogram acquirer engine 340 generates cryptogram 150 without the assistance of operations system 120 by cryptographically signing an operation identifier. After obtaining cryptogram 150, in various embodiments, cryptogram acquirer engine 340 stores it in database 310 and returns it to the issuer of cryptogram request 152.

Token generator engine 350, in various embodiments, is software that is executable to generate token 140. Token generator engine 350 may generate token 140 in a variety of different ways. In some embodiments, token generator engine 350 generates information that identifies input parameters for an operation and provides that information to service provider system 110 as token 140. As an example, in the context of transaction processing, token generator engine 350 may generate a primary account number that is to be used in a transaction between a merchant and a user and may provide that primary account number (along with other information, such as merchant details) to service provider system as token 140. The primary account number may serve as a reference to information (e.g., credit card details) provided in token generation request 144. In some embodiments, operations system 120 stores a mapping between primary account numbers and different user credit card details. When token 140 is later received by operations system 120, operations system 120 may look up the referenced information using the primary account number as a key and use that referenced information in the transaction between the user and the merchant. In some embodiments, token generator engine 350 generates a nonce or other value that it links to the requested operation and involved parties specified in token generation request 144 and encrypts that nonce to form token 140. When token 140 is later received by operations system 120, operations system 120 may decrypt it and then use it to lookup information (e.g., input parameters) for performing the requested operation. As discussed, service provider system 110 may generate token 140. Accordingly, when receiving token 140, operations system 120 may validate token 140 (e.g., validate the cryptographic signature) and perform the requested operation if it is valid.

Cryptogram generator engine 360, in various embodiments, is software executable to generate cryptogram 150. Cryptogram generator engine 360 may generate cryptogram 150 in a variety of different ways. In some embodiments, cryptogram generator engine 360 generates a message, stores it, and hashes (e.g., using MD-5, SHA-256, RIPEMD-160, etc.) the message to produce cryptogram 150. When cryptogram 150 is received with token 140 by operations system 120, operations system 120 may use token 140 to retrieve the stored message, hash the message, and then compare the hashed massage with cryptogram 150 to validate cryptogram 150 (e.g., if they match, then cryptogram 150 is authentic). After validating cryptogram 150, operations system 120 may then perform the requested operation. In some embodiments, cryptogram generator engine 360 generates a message and encrypts the message to produce cryptogram 150. The message may identify token 140. When cryptogram 150 is later received with token 140 by operations system 120, operations system 120 may decrypt cryptogram 150 in order to determine if it identifies token 140.

Token 140 and cryptogram 150 may be obtained by service provider system 110 at relatively the same time or at different times. In some cases, generating cryptogram 150 is a resource intensive operation and thus it may not be desirable to perform that operation until a web service system 130 is seeking to use token 140 to cause operations system 120 to perform certain operations. For example, in the context of transaction processing, a web service system 130 may obtain token 140 for a transaction between a user and a merchant. In some cases, the web service system 130 may determine not to perform the transaction (e.g., an item is out of stock). As such, obtaining cryptogram 150 when obtaining token 140 would result in wasting computing resources performing the resource intensive operation to generate cryptogram 150 when cryptogram 150 is not used. To avoid unnecessary performance of the resource intensive operation, in some embodiments, service provider system 110 obtains cryptogram 150 when a web service system 130 intends to use token 140, which was obtained at an earlier point in time.

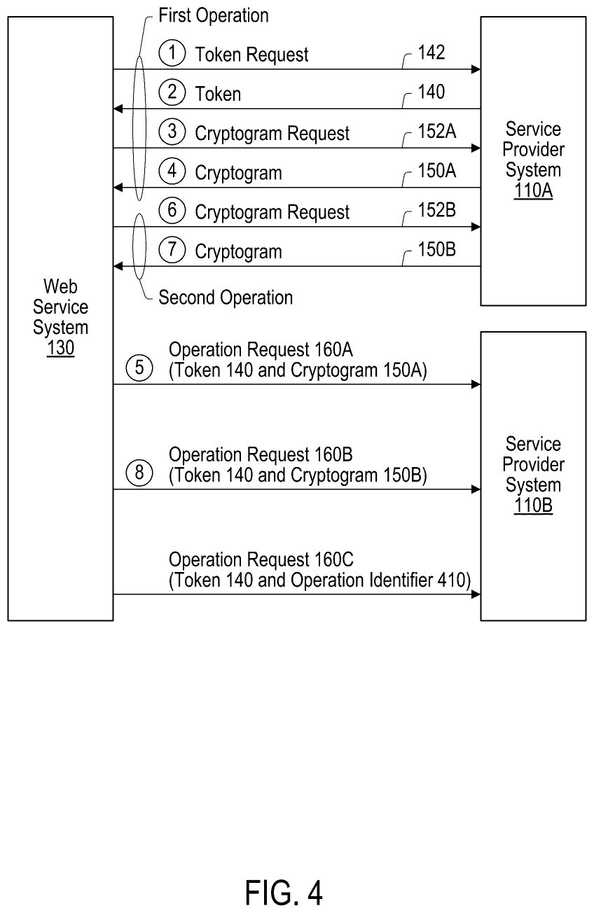

Turning now to FIG. 4, a block diagram of an example in which a web service system 130 acquires a token 140 and multiple cryptograms 150 from a service provider system 110 for use in multiple operations associated with another service provider system 110 is shown. In the illustrated embodiment, there are service provider systems 110A and 110B and a web service system 130. The illustrated embodiment may be implemented differently than shown. As an example, web service system 130 may not be permitted to operation request 160C as it does not include a cryptogram 150.

As discussed, tokens 140 and cryptograms 150 are usable to cause an operations system 120 to perform operations. In various embodiments, tokens 140 are multi-use and thus can be used to cause an operations system 120 perform an operation multiple times. For example, a token 140 may be used to perform multiple transactions between a merchant and a user. While tokens 140 may be multi-use, in various embodiments, cryptograms 150 are single use and thus can be used with token 140 to cause an operations system 120 perform an operation once. To use token 140 multiple times, web service system 130 may obtain multiple cryptograms 150. Furthermore, tokens 140 may be long-lived while cryptograms 150 are short-lived. For example, token 140 may be valid for a month while a given cryptogram 150 is valid for a day and thus web service system 130 may obtain multiple cryptograms 150 over the lifetime of token 140.

In the illustrated embodiment, web service system 130 initially issues a token request 142 to service provider system 110A and receives token 140 in response. Web service system 130 thereafter issues a cryptogram request 152A to service provider system 110A and receives a cryptogram 150A. Web service system 130 issues an operation request 160A (with token 140 and cryptogram 150A) to service provider system 110B to perform a first operation-service provider system 110B may provide token 140 and cryptogram 150A to an operation system 120 that performs the first operation. After the completion of the first operation, web service system 130 may seek to perform a second operation using token 140. Since web service system 130 already has token 140, it does not have to request it from service provider system 110A. Web service system 130, however, sends a cryptogram request 152B to service provider system 110A for another cryptogram 150 and receives a cryptogram 150B in response. Web service system 130 issues an operation request 160B (with token 140 and cryptogram 150B) to service provider system 110B to perform the second operation. In some embodiments, web service system 130 may perform subsequent operations after an initial operation without having to obtain another cryptogram 150. To perform those subsequent operations, web service system 130 may provide an operation identifier 410 that identifies the initial operation. As shown, web service system 130 issues an operation request 160C (with token 140 and operation identifier 410) to service provider system 110B to perform a subsequent operation.

Turning now to FIG. 5, a block diagram of an example that pertains to the use of tokens 140 and cryptograms 150 in a transaction processing architecture is shown. In the illustrated embodiment, there are transaction processors systems 510A-D (examples of service provider systems 110), a merchant system 520 (an example of a web service system 130), and a payment system 550. As further shown, payment system 550 includes payment network systems 560A-B and a card issuer system 570. Payment system 550, card issuer system 570, or a combination of card issuer system 570 and a payment network system 560 can each be considered an example of an operations system 120, although at different granularities. The illustrated embodiment may be implemented differently than shown. For example, transaction processor system 510A may return a nonce or other information (instead of a token 140 for a token request 142) that can be used to obtain token 140 when obtaining a cryptogram 150. A s another example, there may be multiple merchant systems 520 and/or multiple card issuer systems 570.

The illustrated embodiment is provided as an example and is not intended to limit the scope of this disclosure to this example. This example provides a more in-depth discussion of the example provided at the end of the description pertaining to FIG. 1A. As such, transaction processor system 510A may be service provider system 110A, transaction processor system 510B may be service provider system 110B, payment system 550 may be operations system 120, and merchant system 510 may be web service system 130. Further, transaction processor system 510A may provide an express checkout service that allows users to conduct transactions with a merchant without having to manually enter their financial information (e.g., their credit card details). To use this express checkout service, the merchant of merchant system 520 may incorporate functionality into their merchant site 530 to interact with the service. Through the various communications and interactions between the different systems depicted in FIG. 5, the merchant is able to use the express checkout service provided by transaction processor system 510A while still using the payment processing capabilities provided by transaction processor system 510B. This process leverages token 140 and cryptogram 150 that are understood by payment system 550 to allow for the merchant to utilize different transaction processor systems 510.

Merchant system 520 provides a merchant site 530 comprising various web pages 220, and a user 540 may initially access merchant site 530 using their user device 210 (e.g., via a web browser or an application provided by the merchant of merchant system 520). At some point, user 540 may access a checkout web page 220 of merchant site 530 in which user 540 is prompted to provide information for a transaction between user 540 and the merchant of merchant system 520. When code of that checkout web page 220 is executed, it initializes a token SDK 532 (provided by a provider of transaction processor system 510A) that includes a function to request token 140. User 540 is presented with a payment sheet 534 having various fields in which user 540 can enter the information for the transaction. While not shown, user 540 may provide an email address (or another identifier) that is subsequently sent to transaction processor system 510A and used by transaction processor system 510A to access information about user 540. At least a portion of that information may be returned and presented to user 540 (e.g., shipping address, billing address, and last four digits of credit card). Thereafter, user 540 completes the checkout, resulting in a user request 222 (not shown) being sent to merchant system 520 indicating that user 540 wishes to proceed with the transaction. A token request 142 is also sent to transaction processor system 510A to acquire token 140—token request 142 may be issued by user 540's device (e.g., using token SDK 532) or merchant system 520 upon receiving user request 222, as discussed previously. Token request 142 can include merchant information about the merchant (e.g., a merchant ID) and information about the transaction instrument used by user 540.

Upon receiving token request 142, transaction processor system 510A obtains token 140 for the transaction. Based on the transaction instrument being used, transaction processor system 510A may identify a payment network system 560 for that transaction instrument and send a token generation request 144 to that payment network system 560. As an example, user 540 may use a credit card that was issued in connection with payment network system 560A (e.g., MASTERCARD) and thus transaction processor system 510A sends its token generation request 144 to payment network system 560A instead of payment network system 560B (e.g., VISA). As part of communicating with the identified payment network system 560, transaction processor system 510A may also authenticate itself to that payment network system 560 using any of a variety of authentication protocols (e.g., Open Authorization 2.0 (OAuth 2.0)). Token generation request 144 may include a TRID of transaction processor system 510A, merchant information about the merchant and information about the transaction instrument used by user 540. The identified payment network system 560 communicates with card issuer system 570 (which issued user 540's transaction instrument) to obtain token 140 and card issuer system 570 generates token 140 and associates it with the TRID, the merchant information, and the transaction instrument information. Card issuer system 570 returns token 140 to the identified payment network system 560. Token 140 is returned to transaction processor system 510A and subsequently to merchant system 520. As discussed, tokens 140 may be sent directly to a web service system 130 (merchant system 520 in the illustrated embodiment) or indirectly by routing them through a user device 210 to that web service system 130. In some embodiments, transaction processor system 510A generates token 140 itself or in combination with payment system 550.

After receiving token 140, merchant system 520 may wait for a certain period of time (e.g., 24 hours) or until a certain event occurs (e.g., the shipping of an item) before performing the transaction between the merchant and user 540. When seeking to perform the transaction, merchant system 520 may determine whether the transaction is a customer-initiated transaction (CIT) in which user 540 is present or a merchant-initiated transaction (MIT) in which user 540 is not present. As an example of a CIT and an MIT, a user may subscribe to a service, resulting in a transaction in which the user is present—a CIT—and after a month passes, the user may be automatically charged a subscription fee, resulting in another transaction for which the user is not present—an MIT. If merchant system 520 determines that the transaction is a CIT, then merchant system 520 sends a cryptogram request 152 (with token 140) to transaction processor system 510A for a cryptogram 150. In response, transaction processor system 510A issues a cryptogram generation request 154 to the identified payment network system 560—that request may include the TRID of transaction processor system 510A and token 140. The identified payment network system 560 communicates with card issuer system 570 to obtain cryptogram 150 and card issuer system 570 generates and returns cryptogram 150 to the identified payment network system 560. Cryptogram 150 is then returned to transaction processor system 510A and subsequently to merchant system 520. Due to the computing cost in generating cryptogram 150, transaction processor system 510A may obtain cryptogram 150 from card issuer system 570 upon receiving cryptogram request 152. But in some cases, transaction processor system 510A may obtain cryptogram 150 when it obtains token 140 from card issuer system 570. In some embodiments, transaction processor system 510A generates cryptogram 150 itself or in combination with payment system 550.

After obtaining both token 140 and cryptogram 150, merchant system 520 then issues an operation request 160 (with token 140 and cryptogram 150) to another transaction processor system 510 to perform the transaction. As an example, the merchant may use ADYEN as their transaction processor and thus merchant system 520 issues operation request 160 to transaction processor system 510C. As tokens 140 and cryptograms 150 are transaction processor agnostic in various embodiments, the merchant may use any of various different transaction processors to facilitate the transaction. Upon receiving operation request 160, the particular transaction processor system 510 sends an operation initiation request 165 (with token 140 and cryptogram 150) to the relevant payment network system 560, which routes token 140 and cryptogram 150 to card issuer system 570. Card issuer system 570 validates token 140 and cryptogram 150 and then conducts the transaction between the merchant and user 540 in response to both token 140 and cryptogram 150 being valid. Merchant system 520 may conduct a subsequent transaction with the user that is an MIT. In various embodiments, because the transaction is an MIT, merchant system 520 does not obtain another cryptogram 150. Instead, merchant system 520 issues, to the relevant transaction processor system 510, an operation request 160 that includes token 140 and a first network transaction ID (an example of an operation ID 410) that identifies the first transaction conducted using token 140.

By implementing the techniques discussed herein, including the use of tokens 140 and cryptograms 150, transaction processor system 510A can provide functionality to merchant system 520 as part of the transaction/execution flow between user 540 accessing merchant site 530 and the completion of the transaction. That is, for example, transaction processor system 510A can allow for merchant system 520 to use a transaction instrument of user 540 without 1) user 540 having to manually input transaction instrument details and 2) the merchant having to switch from using the particular transaction processor system 510 for which their merchant system 520 was designed.

Turning now to FIG. 6, a block diagram of an example approach pertaining to a service provider system 110 revoking tokens 140 is shown. In the illustrated embodiment, there is a service provider system 110, operations system 120, and user device 210. In many cases, it may be desirable to revoke tokens 140. For example, a user may not wish to use functionality provided by service provider system 110 and thus unsubscribe from that service. A particular token 140 may have been provided to a web service system 130 as a part of facilitating that functionality on behalf of the user. It may be desirable to revoke that particular token 140 to prevent that web service system 130 from continuing to use it on behalf of the user. As another example, a web service system 130 may use a particular token 140 in a manner that conflicts with an agreement or policy associated with that particular token 140, and therefore it may be desirable to revoke it.

As shown, service provider system 110 receives a revoke token request 610 issued by a user device 210 to revoke a set of tokens 140. Revoke token request 610 may not expressly identify the set of tokens 140 but include information usable to determine the set of token 140. For example, revoke token request 610 may include user information about the user that can be used to lookup the set of tokens 140. Accordingly, based on revoked token request 610, in various embodiments, service provider system 110 locates the set of tokens 140 to be invoked and then issues an initiation request 630 to operations system 120 to revoke the set of tokens 140. Revoke initiation request 630 may identify the set of tokens 140 and also include a token requestor identifier (e.g., the one discussed in regard to FIG. 3) used by service provider system 110 to obtain the set of tokens 140. In various embodiments, the token requestor identifier indicates that service provider system 110 system has authority to revoke the set of tokens 140. Upon receiving revoke initiation request 630, operations system 120 may then revoke the set of tokens 140.

In some embodiments, operations system 120 provides usage information 620 relating to the use of tokens 140 that were provided to service provider system 110. For example, usage information 620 can indicate the number of times that a particular token 140 has been used and when that token 140 was used. In various embodiments, service provider system 110 analyzes usage information 620 to identify potential misuses of tokens 140 by web service systems 130. In response to detecting that a particular token 140 has been misused, service provider system 110 may issue revoke initiation request 630 to operations system 120 to revoke that particular token 140. As an example, in the context of transaction processing, a web service system 130 may conduct MITs without obtaining cryptograms 150 from service provider system 110 after conducting an initial CIT in which a token 140 and a cryptogram 150 were used. Accordingly, that web service system 130 may conduct transactions that conflict with the expected/agreed upon use of that token 140. Accordingly, based on a detection (e.g., via usage information 620) that the web service system 130 failed to communicate with service provider system 110 when using the token 140 for one or more subsequent transactions, service provider system 110 may issue a revoke initiation request 630 to operations system 120 to revoke that token 140.

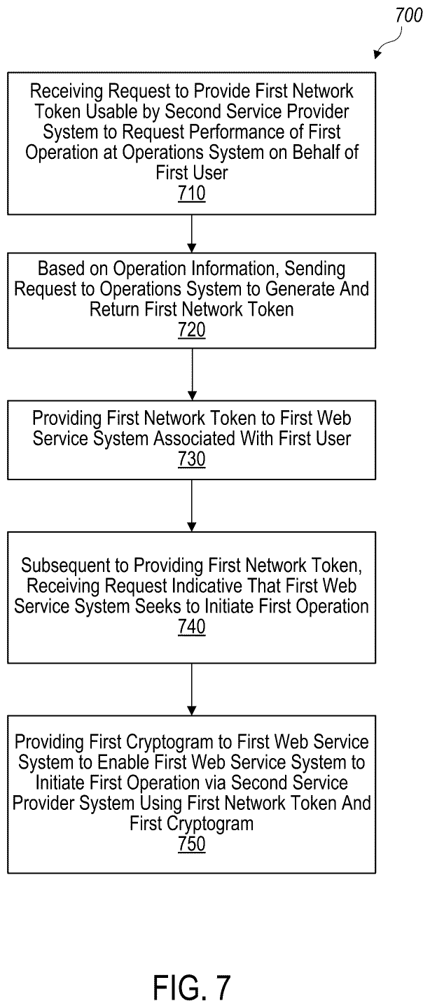

Turning now to FIG. 7, a flow diagram of a method 700 is shown. Method 700 is one embodiment of a method performed by a first service provider system (e.g., a service provider system 110) to facilitate an operation at an operations system (e.g., an operations system 120) using network tokens (e.g., tokens 140) and cryptograms (e.g., cryptograms 150). Method 700 may be performed by executing program instructions stored on a non-transitory computer-readable medium. Method 700 may include more or less steps than shown—e.g., a step in which the first service provider system revokes a network token in response to receiving, from a user (e.g., a user 540) via a user device (e.g., a user device 210), a request (e.g., a revoke token request 610) to revoke the network token on behalf of the user.

Method 700 begins in step 710 with the first service provider system receiving a request (e.g., a token request 142) to provide a first network token that is usable by a second service provider system (e.g., another service provider system 110) to request performance of a first operation (e.g., a transaction) at the operations system on behalf of a first user. The request includes operation information (e.g., information pertaining to the first user, the user's device, the provider of a web service system, and/or the web service system itself) associated with the first operation.

In step 720, based on the operation information, the first service provider system sends a request (e.g., token generation request 144) to the operations system to generate and return the first network token. In various embodiments, the first network token is usable with a first cryptogram to collectively cause the operations system to perform the first operation. The first service provider system may store a plurality of network tokens for a plurality of web service systems (e.g., web service systems 130). The plurality of network tokens may include the first network token and a second network token that enables a first web service system to conduct a second operation for a second user via the second service provider system.

In step 730, the first service provider system then provides the first network token to the first web service system associated with the first user. In step 740, subsequent to providing the first network token, the first service provider system receives a request (e.g., a cryptogram request 152) indicative that the first web service system seeks to initiate the first operation. In step 750, the first service provider system provides the first cryptogram to the first web service system to enable the first web service system to initiate the first operation via the second service provider system using the first network token and the first cryptogram. The first network token may be usable for conducting a plurality of operations but the first cryptogram may be usable for conducting a single operation. The first network token may be usable without a cryptogram to perform, after completion of the first operation, one or more subsequent operations for the first user.

The first service provider system may be a first transaction processor system (e.g., a transaction processor system 510), the second service provider system may be a second transaction processor system (e.g., a transaction processor system 510), the operations system may be a payment system (e.g., a payment system 550), and the first web service system may be a merchant system (e.g., a merchant system 520). Subsequent to completion of the first operation, the first service provider system may receive a request from the first web service system to provide a second cryptogram that is usable with the first network token to conduct a second operation for the first user. The first service provider system may then obtain the second cryptogram from the operations system and provides it to the first web service system.

The first service provider system may provide, to a second web service system that is associated with a second user, a second network token usable by a third service provider system to facilitate a second operation for the second user. After the providing of the second network token to the second web service system, the first service provider system may receive a request indicative that the second web service system seeks to complete the second operation. The first service provider system may provide a second cryptogram to the second web service system to enable the second service provider system to conduct the second operation via the third service provider system using the second network token and the second cryptogram.

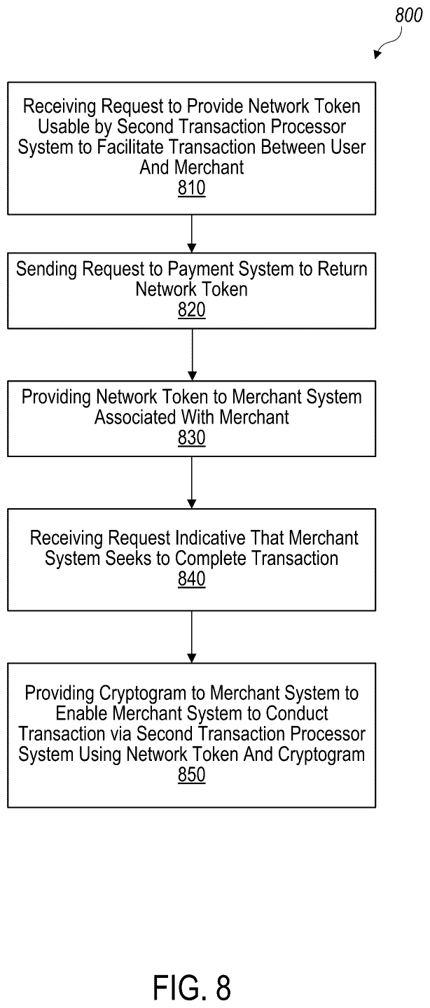

Turning now to FIG. 8, a flow diagram of a method 800 is shown. Method 800 is one embodiment of a method performed by a first service provider system (e.g., a service provider system 110) to facilitate a transaction using network tokens (e.g., tokens 140) and cryptograms (e.g., cryptograms 150). Method 800 may be performed by executing program instructions stored on a non-transitory computer-readable medium. Method 800 may include more or less steps than shown—e.g., a step in which the first service provider system revokes a network token in response to receiving, from a user (e.g., a user 540) via a user device (e.g., a user device 210), a request (e.g., a revoke token request 610) to revoke the network token on behalf of the user.

Method 800 begins in step 810 with the first service provider system receiving a request (e.g., a token request 142) to provide a network token usable by a second transaction processor system (e.g., another service provider system 110) to facilitate a transaction between a user and a merchant. In step 820, the first service provider system sends a request (e.g., a token generation request 144) to a payment system (e.g., a payment system 550) to return the network token. In various embodiments, the network token is usable with a cryptogram to collectively cause the payment system to perform the transaction. In step 830, the first service provider system provides the network token to a merchant system (e.g., a merchant system 520) that is associated with the merchant. In step 840, the first service provider system receives a request (e.g., a cryptogram request 152) that is indicative that the merchant system seeks to complete the transaction. In step 850, the first service provider system provides the cryptogram to the merchant system to enable the merchant system to conduct the transaction via the second transaction processor system using the network token and the cryptogram.

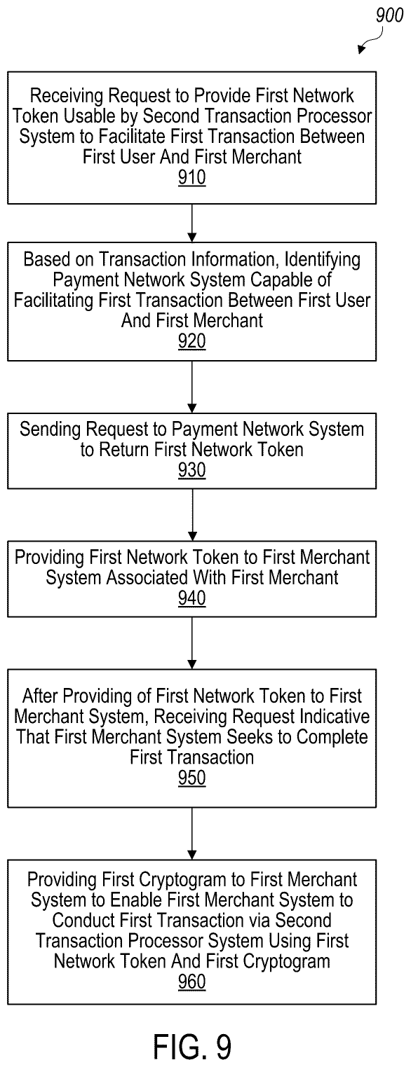

Turning now to FIG. 9, a flow diagram of a method 900 is shown. Method 900 is one embodiment of a method performed by a first transaction processor system (e.g., a transaction processor system 510) to facilitate a transaction using network tokens (e.g., tokens 140) and cryptograms (e.g., cryptograms 150). Method 900 may be performed by executing program instructions stored on a non-transitory computer-readable medium. Method 900 may include more or less steps than shown—e.g., a step in which the first transaction processor system deletes at least one of a plurality of stored network tokens in response to determining that the at least one network token has become invalid.

Method 900 begins in step 910 with the first transaction processor system receiving a request (e.g., a token request 142) to provide a first network token that is usable by a second transaction processor system (e.g., another transaction processor system 510) to facilitate a first transaction between a first user and a first merchant. The request may include transaction information about the first transaction (e.g., merchant and transaction instrument details). In some cases, the request to provide the first network token is received from a first merchant system (e.g., a merchant system 520) of the first merchant. In some cases, the request to provide the first network token is received from a user device (e.g., a user device 210) of the first user. Thus, providing the first network token to the first merchant system may include routing the first network token through the user device. In step 920, based on the transaction information, the first transaction processor system identifies a payment network system (e.g., a payment network system 560) capable of facilitating the first transaction between the first user and the first merchant.

In step 930, the first transaction processor system then sends a request (e.g., a token generation request 144) to the payment network system to return the first network token. In various embodiments, the first network token is usable with a first cryptogram to collectively cause a card issuer system (e.g., a card issuer system 570) associated with the payment network system to perform the first transaction. The request to the payment network system may include a token requestor identifier associated with the first transaction processor system, merchant information describing the first merchant, and transaction instrument information describing a transaction instrument associated with the first user. The first transaction processor system may store a plurality of network tokens for a plurality of merchant systems. The plurality of network tokens may include the first network token and a second network token that enables the first merchant to conduct a second transaction with a second user via the second transaction processor system.

In step 940, the first transaction processor system provides the first network token to the first merchant system associated with the first merchant. In step 950, after providing of the first network token to the first merchant system, the first transaction processor system receives a request (e.g., a cryptogram request 152) that is indicative that the first merchant system seeks to complete the first transaction.

In step 960, the first transaction processor system provides the first cryptogram to the first merchant system to enable the first merchant system to conduct the first transaction via the second transaction processor system using the first network token and the first cryptogram. In various embodiments, the first network token is transaction processor system independent such that the first network token is usable by a third transaction processor system to facilitate the first transaction between the first user and the first merchant. The first network token may be usable for conducting a plurality of transactions but the first cryptogram may be usable for conducting a single transaction. The first network token may be usable without a cryptogram to perform, after completion of the first transaction, one or more subsequent transactions on behalf of the first user. Further, the first cryptogram may be associated with an expiration time that is indicative of when the first cryptogram is no longer usable with the first network token to cause the card issuer system to perform the first transaction.

Subsequent to completion of the first transaction, the first transaction processor system may receive a request from the first merchant system to provide a second cryptogram that is usable with the first network token to conduct a second transaction between the first user and the first merchant. Accordingly, the first transaction processor system may obtain the second cryptogram from the payment network system and provide it to the first merchant system. The first transaction processor system may provide, to a second merchant system that is associated with a second merchant, a second network token usable by a third transaction processor system to facilitate a second transaction between a second user and the second merchant. After providing the second network token to the second merchant system, the first transaction processor system may receive a request indicative that the second merchant system seeks to complete the second transaction. The first transaction processor system may provide a second cryptogram to the second merchant system to enable the second merchant system to conduct the second transaction via the third transaction processor system using the second network token and the second cryptogram.

The first transaction processor system may receive, from the first user via a user device, a request (e.g., a revoke token request 610) to revoke the first network token. Accordingly, the first transaction processor system may send a revoke request (e.g., a revoke initiation request 630) to the payment network system to revoke the first network token. The revoke request may include a token requestor identifier used by the first transaction processor system to obtain the first network token. In various embodiments, the token requestor identifier is indicative that the first transaction processor system has authority to revoke the first network token. In some cases, the first transaction processor system sends a revoke request to the payment network system to revoke the first network token based on a detection (e.g., based on usage information 620) that the first merchant system failed to communicate with the first transaction processor system when using the first network token for a second transaction.

### Exemplary Computer System

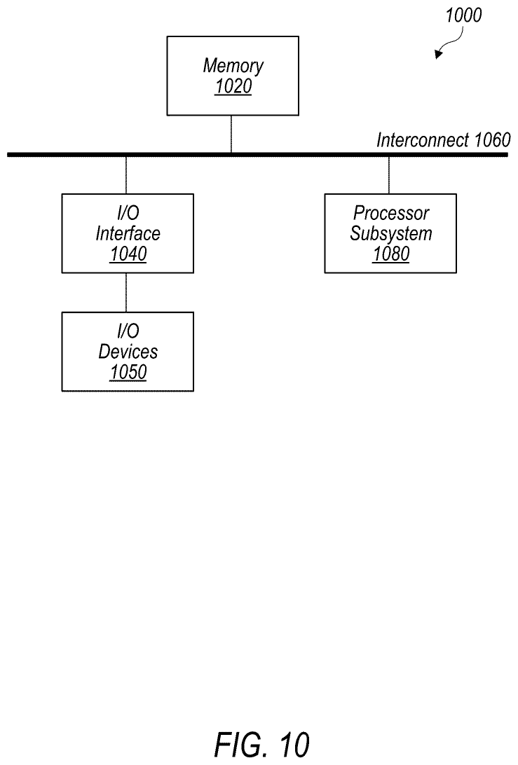

Turning now to FIG. 10, a block diagram of an exemplary computer system 1000, which may implement service provider systems 110, operations systems 120, web service systems 130, and/or user devices 210, is shown. Computer system 1000 includes a processor subsystem 1080 that is coupled to a system memory 1020 and I/O interfaces(s) 1040 via an interconnect 1060 (e.g., a system bus). I/O interface(s) 1040 is coupled to one or more I/O devices 1050. Although a single computer system 1000 is shown in FIG. 10 for convenience, system 1000 may also be implemented as two or more computer systems operating together.

Processor subsystem 1080 may include one or more processors or processing units. In various embodiments of computer system 1000, multiple instances of processor subsystem 1080 may be coupled to interconnect 1060. In various embodiments, processor subsystem 1080 (or each processor unit within 1080) may contain a cache or other form of on-board memory.

System memory 1020 is usable store program instructions executable by processor subsystem 1080 to cause system 1000 perform various operations described herein. System memory 1020 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 1000 is not limited to primary storage such as memory 1020. Rather, computer system 1000 may also include other forms of storage such as cache memory in processor subsystem 1080 and secondary storage on I/O Devices 1050 (e.g., a hard drive, storage array, etc.). In some embodiments, these other forms of storage may also store program instructions executable by processor subsystem 1080. In some embodiments, program instructions that when executed implement token acquirer engine 330, cryptogram acquirer engine 340, token generator engine 350, and/or cryptogram generator engine 360 may be included/stored within system memory 1020.

I/O interfaces 1040 may be any of various types of interfaces configured to couple to and communicate with other devices, according to various embodiments. In one embodiment, I/O interface 1040 is a bridge chip (e.g., Southbridge) from a front-side to one or more back-side buses. I/O interfaces 1040 may be coupled to one or more I/O devices 1050 via one or more corresponding buses or other interfaces. Examples of I/O devices 1050 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 1000 is coupled to a network via a network interface device 1050 (e.g., configured to communicate over Wifi, Bluetooth, Ethernet, etc.).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a first service provider system, a request to provide a first network token that is usable by a second service provider system to request performance of a first operation at an operations system on behalf of a first user, wherein the request includes operation information associated with the first operation;
based on the operation information, the first service provider system sending a request to the operations system to generate and return the first network token, wherein the first network token is usable with a first cryptogram to collectively cause the operations system to perform the first operation;
providing, by the first service provider system, the first network token to a first web service system associated with the first user;
subsequent to providing the first network token, the first service provider system receiving a request indicative that the first web service system seeks to initiate the first operation; and
providing, by the first service provider system, the first cryptogram to the first web service system to enable the first web service system to initiate the first operation via the second service provider system using the first network token and the first cryptogram.

2. The method of claim 1, further comprising:
storing, by the first service provider system, a plurality of network tokens for a plurality of web service systems, wherein the plurality of network tokens includes the first network token and a second network token that enables the first web service system to initiate a second operation for a second user via the second service provider system.

3. The method of claim 1, further comprising:
providing, by the first service provider system to a second web service system that is associated with a second user, a second network token usable by a third service provider system to facilitate a second operation for the second user;
after the providing of the second network token to the second web service system, the first service provider system receiving a request indicative that the second web service system seeks to initiate the second operation; and
providing, by the first service provider system, a second cryptogram to the second web service system to enable the second web service system to initiate the second operation via the third service provider system using the second network token and the second cryptogram.

4. The method of claim 1, wherein the first network token is service provider system independent such that the first network token is usable by a third service provider system to request performance of the first operation at the operations system on behalf of the first user.

5. The method of claim 1, wherein the first network token is usable for conducting a plurality of operations but the first cryptogram is usable for conducting a single operation.

6. The method of claim 1, further comprising:
subsequent to completion of the first operation, the first service provider system receiving a request from the first web service system to provide a second cryptogram that is usable with the first network token to initiate a second operation for the first user;
obtaining, by the first service provider system, the second cryptogram from the operations system; and
providing, by the first service provider system, the second cryptogram to the first web service system.

7. The method of claim 1, wherein the first network token is usable without a cryptogram to perform, after completion of the first operation, one or more subsequent operations for the first user.

8. The method of claim 1, further comprising:
revoking, by the first service provider system, the first network token in response to receiving, from the first user via a user device, a request to revoke the first network token on behalf of the first user.

9. The method of claim 1, wherein the request to provide the first network token is received from the first web service system.

10. The method of claim 1, wherein the request to provide the first network token is received from a user device of the first user.

11. The method of claim 10, wherein the providing of the first network token to the first web service system includes routing the first network token through the user device.

12. A non-transitory computer-readable medium having program instructions stored thereon that are executable by a first service provider system to cause the first service provider system to perform operations comprising:
receiving a request to provide a first network token usable by a second service provider system to facilitate a first operation between a first entity and a second entity, wherein the request includes operation information about the first operation;
based on the operation information, identifying a first operations system capable of facilitating the first operation between the first and second entities;
sending a request to the first operations system to return the first network token, wherein the first network token is usable with a first cryptogram to collectively cause the first operations system to perform the first operation;
providing the first network token to a first web service system associated with the first entity;
after the providing of the first network token to the first web service system, receiving a request indicative that the first web service system seeks to initiate the first operation; and
providing the first cryptogram to the first web service system to enable the first web service system to initiate the first operation via the second service provider system using the first network token and the first cryptogram.

13. The non-transitory computer-readable medium of claim 12, wherein the operations further comprise:
storing a plurality of network tokens for a plurality of web service system, including the first network token and a second network token that is associated with the first web service system but with a third entity; and
deleting at least one of the plurality of network tokens in response to determining that the at least one network token has become invalid.

14. The non-transitory computer-readable medium of claim 12, wherein the operations further comprise:
receiving a request from the first web service system to provide a second cryptogram so that the first web service system is able to initiate a second operation between the first and second entities;
obtaining the second cryptogram from the first operations system; and
providing the second cryptogram to the first web service system.

15. The non-transitory computer-readable medium of claim 12, wherein the operations further comprise:
sending a set of requests to a second operations system to return a second network token and a second cryptogram that are collectively usable by the first web service system to initiate a second operation between the first and second entities; and
providing the second network token and the second cryptogram to the first web service system.

16. The non-transitory computer-readable medium of claim 12, wherein the first cryptogram is associated with an expiration time that is indicative of when the first cryptogram is no longer usable with the first network token to initiate the first operation at the first operations system.

17. A first service provider system, comprising:
at least one processor; and
memory having program instructions stored thereon that are executable by the at least one processor to cause the first service provider system to perform operations comprising:
receiving a request to provide a first network token usable by a second service provider system to facilitate a first operation at an operations system on behalf of a first user;
sending a request to the operations system to return the first network token, wherein the first network token is usable with a first cryptogram to collectively cause the operations system to perform the first operation;
providing the first network token to a first web service system associated with the first user;
after the providing of the first network token to the first web service system, receiving a request indicative that the first web service system seeks to initiate the first operation; and
providing the first cryptogram to the first web service system to enable the first web service system to initiate the first operation via the second service provider system using the first network token and the first cryptogram.

18. The first service provider system of claim 17, wherein the operations further comprise:
storing a plurality of network tokens for a plurality of web service systems, including the first network token and a second network token that is associated with the first web service system but with a second user.

19. The first service provider system of claim 17, wherein the operations further comprise:
receiving a request from the first web service system to provide a second cryptogram so that the first web service system is able to initiate a second operation at the operations system on behalf of the first user;
obtaining the second cryptogram from the operations system; and
providing the second cryptogram to the first web service system.

20. The first service provider system of claim 17, wherein the operations further comprise:
providing, to a second web service system, a second network token and a second cryptogram usable by a third service provider system to facilitate a second operation at the operations system on behalf of a second user.
